(19) United States
(12) Patent Application Publication
(10) Pub. No.: US 2003/0010206 A1
(43) Pub. Date: Jan. 16, 2003

(54) Apparatus and method for deodorizing air

(75) Inventors: Jeffrey Donald Painter, Loveland, OH (US); Frank Andrej Kvietok, Cincinnati, OH (US); Toan Trinh, Maineville, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/211,108

(22) Filed: Aug. 2, 2002

Related U.S. Application Data
(63) Continuation of application No. PCT/US00/05403, filed on Mar. 2, 2000.

(51) Int. Cl. B01D 53/02

(52) U.S. Cl. 95/90; 96/108

(57) ABSTRACT

The present invention relates a method and an apparatus for removing malodor from the air. Such methods and devices are useful for example for storing and preserving food in closed compartments such as refrigerators. The method of the present invention comprises the steps of positioning first filter member inside said confined space independent from the position of a second filter member and of removing malodor molecules from the air of said confined space by adsorbing said molecules onto the surfaces of said first filter member and onto the surfaces of said second filter member. The apparatus of the present invention is characterized in that a first filter member is attachable to an air moving member and a second filter element is attachable to the air moving member.

### CROSS REFERENCE TO RELATED APPLICATIONS

This is a continuation of International Application PCT/US/00/05403 with an international filing date of Mar. 2, 2000.

### FIELD OF THE INVENTION

The present invention relates a method and an apparatus for removing malodor from the air. Such methods and devices are useful for example for storing and preserving food in closed compartments such as refrigerators.

### BACKGROUND

Nowadays, refrigerators have become a common appliance in virtually every household and typically are used for storage and preservation of food, in particular of fresh food such as fruits, vegetables, dairy products, and the like. It is desirable to keep the food items fresh as long as possible in the refrigerator.

It is a well known problem that many food items tend to release malodors into the air which are then captured in the limited air space in a refrigerator. Not only are these malodors unpleasant and offensive to the user of the refrigerator, they can also have a negative impact on the quality of other foods in the refrigerator. For example, it is known that some foods emit strong odors (e.g. fish, boiled eggs, onions, etc.) and that these odors can transfer to other nearby foods and hurt the taste and freshness of those foods. A common example is transfer of odors into an open container of orange juice or of milk resulting in a noticeable degradation in their taste. It is also well known that malodors from some vegetables (onions, garlic) can transfer to other foods stored within a vegetable drawer. This problem is aggravated when the vegetable drawer is sealed such that there is very little air exchange with the larger compartment of the refrigerator (herein referred to as the “fresh food compartment”) and when vegetables have been cut or are stored without any outer wrapping. This problem of odor transfer is particularly acute in the case of ice cubes where odors from the fresh food compartment of the refrigerator can be transferred to the ice in the freezer compartment of the refrigerator. This is especially true in the case of refrigerators in which there is air exchange between the fresh food and freezer compartments, and especially in the case of refrigerators with built-in ice-makers.

There exist in the art devices for deodorizing confined spaces such as disclosed for example in U.S. Pat. No. 5, 403,548 and in U.S. Pat. No. 5,772,959. However, these devices as such fail to be capable of deodorizing those complexly structured confined spaces which comprise portions which are not reached by normal air convection. In these portions which include for example drawers for fresh fruits and vegetables in a refrigerator, malodors may be trapped and hence may not be reached by deodorizing devices placed in the main compartment.

It is therefore an object of the present invention to provide a method and an apparatus for deodorizing confined spaces which overcomes the disadvantages of the prior art.

It is a further object of the present invention to provide a method and apparatus for deodorizing confined spaces which are capable of deodorizing confined spaces comprising portions which are not accessible to normal air convection to an extent allowing for deodorization of those portions.

### SUMMARY OF THE INVENTION

It is one aspect of the present invention to provide a method for deodorizing air in confined spaces comprising the steps of

providing a first member comprising a first filter member

providing a second member comprising a second filter member

positioning the first member inside the confined space

positioning the second member inside the confined space independent from the position of the first member

removing malodor molecules from the air of the confined space by adsorbing the molecules onto the surfaces of the first filter member and onto the surfaces of the second filter member.

It is a further aspect of the present invention to provide an apparatus for deodorizing air in confined spaces comprising a first filter member, a second filter member, and an air moving member characterized in that the first filter member is attachable to the air moving member and the second filter element is attachable to the air moving member.

### DETAILED DESCRIPTION OF THE INVENTION

The method and the apparatus for deodorizing air in confined spaces of the present invention is suitable for refrigerators, closets, and the like.

Confined spaces often have complex structures so that normal air convection does not reach every corner of the confined space. Such complex structures for example include separate compartments such as drawers or hollow elements inside the confined space. Therefore, it is insufficient to deodorize such confined spaces with only a single device, even a forced air device having a fan.

With the method of the present invention it is possible to also deodorize those portions of the confined space to which are not sufficiently accessible to normal air convection. This is achieved by utilizing more than one filter member whereby each of those filter members can be positioned independent of each other whereby one of the filter members optionally may be used while connected to an air moving member.

Suitable filter members for the method of the present invention include passive filter members and forced air filter members. The term “passive filter member” as used herein refers to those filter members which only rely on air convection and on diffusion to bring malodors within reach of the filter media in the member. The term “forced air filter member” as used herein refers to those filter members which attached to a forced air moving member which draws air into the device through a filter member containing a filter media and increases air flow through the filter media above that achieved through normal air convection in the confined space. As used within this disclosure, a forced air filter member consists of a filter member and an air moving member. A filter member suitable for the forced air filter members may be a passive filter member according to the above definition.

A confined space for which the method of the present invention is particularly suitable comprises a compartment which is within the confined space but which is separated from the remainder of the confined space. In this case, one of the filter members may be placed in the separate compartment and another filter element may be placed in the remainder of the confined space. With the method of the present invention it is therefore possible to deodorize all compartments being comprised in a confined space such as a refrigerator (which has enclosed compartments for vegetables, meats, etc.), a closet (which has shoe storage closets, clothes storage containers, etc.), or the like. In particular when the separate compartments differ in size, it may be beneficial to place a forced air filter member in the larger compartment and a passive filter member in the smaller compartment.

Deodorization of the air to remove malodors in the device of the present invention may be achieved by adsorbing the molecules constituting a malodor onto a surface of a filter member. The term “adsorption” is well defined in the art and refers to the adherence of molecules to surfaces which effectively reduces the mobility of these molecules to the two dimensions of the surface. Those molecules remaining in the air will then diffuse so that further molecules come into contact with the surface and subsequently will be adsorbed. Consequently, most of the malodor molecules will travel into the proximity of one of the surfaces at some point in time so that finally most of the malodor will be removed from the air.

A filter member suitable to be used in the first member and/or in the second member of the present invention may comprise activated carbon for the adsorption. Activated carbon is known to be a very effective filter medium due to its high specific surface area. Whilst activated carbon is very effective as such, the filter member of the present invention may further comprise agents supported on the activated carbon to specifically attack certain malodors such as those comprising S atoms or N atoms. A wide variety of activated carbon based filter media is known in the art. Preferably, the filter members of the present invention comprise at least 2 grams, more preferably at least 5 grams, and most preferably at least 10 grams of activated carbon. Preferably, the filter members of the present invention comprise less than 100 grams, more preferably less than 50 grams, yet more preferably less than 40 grams, and most preferably less than 30 grams of activated carbon. Alternatively, the filter member of the present invention may comprise a filter medium capable of removing ethylene from the air, such as a filter medium comprising potassium permanganate.

The filter members of the present invention comprise an air inlet, an air outlet, and an air flow path through the filter member from the air inlet to the air outlet. The filter medium is disposed in the filter member of the present invention such that it comes into contact with the air flowing along the air flow path. The filter medium may be arranged as a flow by filter or as a flow through filter. The filter member of the present invention may comprise a support for the filter medium for example in the form of a foam, a nonwoven material or a woven material.

The deodorization of the air in the forced air device of the present invention is enhanced by increasing the air flow through the filter member by means of an air moving member. Preferably, the air moving means moves at least 100 ml of air per second through the air inlet into the device, more preferably at least 200 ml/s, most preferably at least 300 ml/s. There are known in the art a wide variety of suitable air moving members such as for example fans and blowers. A particularly suitable fan is a centrifugal fan. A suitable member for driving the fan is a small motor, for example a DC motor available from MABUCHI MOTOR CO.,LTD., Japan, under the designation of RF-330TK. The air moving members of the present invention are powered electrically. Many electrical power sources could be imagined including domestic AC electrical power or power from a static power supply. Alternatively and preferably electrical power may be supplied by means of a battery, preferably a dry alkaline cell battery, or a rechargeable battery. Any replaceable power supply preferably is designed to last at least one month, more preferably at least two month, yet more preferably at least three months, most preferably at least four months.

A forced air device will enable adsorption of more malodors to happen more quickly than a passive device by increasing the rate of air contact with the adsorbing media. As such, a forced air device as described above is suitable for use in the large area of a confined space (e.g. the fresh food compartment of a refrigerator, a closet, etc.) as it has the ability to move the relatively large volume of air in these spaces, typically 50 to 800 liters, through the filter media. A passive device is suitable for use in the smaller compartments within a confined space (vegetable drawers, shoe storage containers, etc.) where diffusion alone is effective at moving air to the filter media, and where the air is not accessible to the forced air device.

The apparatus of the present invention preferably comprises an air moving member which can be attached to any one of the at least two filter members of the apparatus. This greatly enhances the flexibility of the use of the apparatus of the present invention. The term “attach” as used herein refers to installation and removal of filter members to and from the air moving member, in particular where no tools such as screw drivers are needed. Preferably, no excessive forces are needed for attaching the filter means, the filter means are directly accessible from the outside, and the filter member can be removed by holding the device of the present invention in one hand and by removing the filter member with the other hand. The filter members of the apparatus of the present invention can have any size and shape as long as they are attachable to the air moving member and can also be of the same shape and/or of the same size.

Preferably, filter elements and air moving member are designed such that any air that is drawn into the air moving member is forced to flow through the attached filter member before penetrating into the air moving member. By this construction, the mechanical complexity of the apparatus of the present invention is reduced since only one connection between filter member and air moving member is needed.

### Article of Manufacture

The present invention also encompasses an article of manufacture which can provide several benefits, especially in confined spaces such as refrigerators, including, but not limited to: removing malodor from said confined spaces; removing ethylene from said confined spaces; maintaining the fresh odor of said confined spaces; reducing the transfer of airborne bacteria in said confined spaces; maintaining the freshness of food items; improving the quality of food items; maintaining the fresh taste of food items; preventing the transfer of odors between two food items; extending the useful life of food items; keeping food items fresh over a longer period of time; reducing spoilage of food items; reducing the incidence of freezer burn of food items in a freezer compartment; maintaining the fresh taste and/or odor of ice cubes (preferably ice cubes made by an automatic ice maker); increasing the cooling efficiency of a refrigerator; ______ ; and ______ [other benefits?]. The article of manufacture generally comprises: (a) an apparatus selected from the group consisting of a passive filter member, a forced air filter member, and combinations thereof; (b) optionally, a package containing said apparatus; and (c) informational indicia, including printed matter such as a set of instructions, in association with said apparatus or said package to communicate said benefits to a consumer.

The present invention further relates to the use of said apparatus to achieve said benefits (i.e. technical effects).

Apparatus

An apparatus useful in the present article of manufacture includes either a passive filter member, a forced air filter member, or combinations thereof. Suitable passive and forced air filter members have been described in detail hereinbefore.

Optional Package

The present article of manufacture can optionally comprise a package containing said apparatus. The apparatus is preferably contained in a package that protects the apparatus during shipment and/or makes the apparatus easier to display in a retail store or more appealing to consumers. The optional package can be any number of suitable packages, including but not limited to: cardboard boxes, bubble-wrap films, ______ and ______ . [[[what other types of packaging would one use to package these air filter devices???]]]

Informational Indicia

An important element of the present article of manufacture is informational indicia which communicates the benefits (i.e. technical effects) of the apparatus to consumers. Without the informational indicia, consumers who otherwise might not use the apparatus (e.g. because they were not aware of the potential benefits/technical effects derived from using the apparatus), will use the apparatus to obtain the benefits, such as improving the quality of food, which can lead to improving the consumers' lives.

Informational indicia can be in association with the apparatus itself or, when the present article comprises a package, in association with the package. As used herein, the phrase “in association with” means the informational indicia (e.g. set of instructions) are either directly printed on the apparatus itself (or package itself) or presented in a different manner including, but not limited to, a brochure, print advertisement, electronic advertisement, and/or verbal communication, so as to communicate the set of instructions to a consumer of the article of manufacture. Informational indicia can include, but is not limited to: a set of instructions that direct a consumer to communicate the benefits and steps needed to be carried out (such as the methods of use described herein) to obtain the communicated benefits; diagrams, pictures, and/or logos which communicate the benefits and steps need to be carried out to obtain the benefits; and the like. As mentioned hereinbefore, the informational indicia can either be printed directly on the apparatus (or package) or can be provided along with the apparatus (or package) such as in a product brochure.

In one embodiment, the informational indicia is printed matter in the form of a set of instructions for use in association with the apparatus and/or package. The set of instructions comprise an instruction to obtain a benefit selected from the group consisting of: removing malodor from said confined spaces; removing ethylene from said confined spaces; maintaining the fresh odor of said confined spaces; reducing the transfer of airborne bacteria in said confined spaces; maintaining the freshness of food items; improving the quality of food items; maintaining the fresh taste of food items; preventing the transfer of odors between two food items; extending the useful life of food items; keeping food items fresh over a longer period of time; reducing spoilage of food items; reducing the incidence of freezer burn of food items in a freezer compartment; maintaining the fresh taste and/or odor of ice cubes (preferably ice cubes made by an automatic ice maker); increasing the cooling efficiency of a refrigerator; ______ [other benefits?]; and combinations thereof; by placing an apparatus selected from the group consisting of a passive filter member, an active filter member, and combinations thereof; in a confined space as described hereinbefore, preferably a refrigerator. The more preferred benefits include ______ , ______ , and ______ . The apparatus in the present article of manufacture is preferably a forced air filter member.

In an alternative embodiment, the set of instructions comprise an instruction to obtain a benefit selected from those described hereinbefore by:

providing a first member comprising a first filter member

providing a second member comprising a second filter member

positioning said first member inside said confined space

positioning said second member inside said confined space independent from the position of said first member

removing malodor molecules from the air of said confined space by adsorbing said molecules onto the surfaces of said first filter member and onto the surfaces of said second filter member.

It should be recognized that the set instructions can comprise instructions which are equivalent to those described herein.

What is claimed is:

1. A method of deodorizing air in a confined space comprising the steps of
providing a first member comprising a first filter member having surfaces;
providing a second member comprising a second filter member having surfaces;
positioning said first member inside said confined space;
positioning said second member inside said confined space independently from the position of said first member; and
removing malodor molecules from the air of said confined space by adsorbing said molecules onto the surfaces of said first filter member and onto the surfaces of said second filter member.

2. A method for deodorizing air in confined spaces according to claim 1 wherein said first member is a forced air filter member comprising an air moving member and said second member is a passive member.

3. A method for deodorizing air in confined spaces according to claim 1 wherein at least one of said first filter member and second filter member comprises activated carbon.

4. A method for deodorizing air in confined spaces according to claim 1 wherein said air moving member comprises a fan and an electrical drive member driving the fan.

5. A method for deodorizing air in confined spaces according to claim 1 said wherein said confined space comprises a compartment which is separate from the remainder of said confined space wherein said second member is positioned inside said compartment and said first member is positioned inside said remainder of said confined space.

6. A method for deodorizing air in a confined space according to claim 1 wherein said confined space is the confined space of a refrigerator.

7. An apparatus for deodorizing air a confined spaces, said apparatus comprising:
a first filter member;
a second filter member; and
an air moving member wherein said first filter member is removably attachable to said air moving member and said second filter element is removably attachable to said air moving member.

8. The apparatus for deodorizing air in confined space according to claim 7 wherein at least one of said first filter member and said second filter member comprise activated carbon.

9. The apparatus for deodorizing air in confined spaces according to claim 28 wherein said confined space is the confined space of a refrigerator.

10. An article of manufacture comprising:
(a) an apparatus selected from the group consisting of:
(i) a passive air filter member;
(ii) a forced air filter member; and
(iii) combinations thereof;
(b) optionally, a package containing said apparatus; and
(c) a set of instructions comprising an instruction to obtain a benefit selected from the group consisting of: removing malodor from said confined spaces; removing ethylene from said confined spaces; maintaining the fresh odor of said confined spaces; reducing the transfer of airborne bacteria in said confined spaces; maintaining the freshness of food items; improving the quality of food items; maintaining the fresh taste of food items; preventing the transfer of odors between two food items; extending the useful life of food items; keeping food items fresh over a longer period of time; reducing spoilage of food items; reducing the incidence of freezer burn of food items in a freezer compartment; maintaining the fresh taste and/or odor of ice cubes; increasing the cooling efficiency of a refrigerator; preventing or reducing formation of ice crystals on ice cream in an opened or partially-sealed box stored in a freezer compartment and combinations thereof; by placing said apparatus in said confined space.

11. The article of manufacture according to claim 10, wherein said confined space is a refrigerator; wherein said apparatus is a forced air filter; and wherein said set of instructions comprises an instruction to maintain the freshness of food items by placing said forced air filter in said refrigerator.

12. The article of manufacture to claim 10, wherein said apparatus comprises a first filter member, a second filter member, and an air moving member; wherein said first filter member is removably attachable to said air moving member and said second filter element is removably attachable to said air moving member; and wherein said set of instructions comprises an instruction to remove malodor from said confined space by positioning said first filter member inside said confined space, positioning said second filter member inside said confined space independent from the position of said first member, and removing malodor molecules from the air of said confined space by adsorbing said molecules onto the surfaces of said first filter member and onto the surfaces of said second filter member.
